(19) United States
(12) Patent Application Publication
(10) Pub. No.: US 2006/0174049 A1
(43) Pub. Date: Aug. 3, 2006

(54) USB to SATA bridge system

(75) Inventors: Teng-Wen Lin, Chiayi City (TW); Wei-Shu Hsu, Jhudong Township (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 11/220,606

(22) Filed: Sep. 8, 2005

(30) Foreign Application Priority Data
Feb. 1, 2005 (TW) 094102987

(51) Int. Cl. G06F 13/36

(52) U.S. Cl. 710/308

(57) ABSTRACT

A bridge system for heter-serial interfaces, which is connected to a host. The bridge system includes a host interface controller, a memory, a controller and a device interface controller. The controller controls the host interface controller and the device interface controller such that the data or commands sent by the host are changed from a host interface format to a device interface format and sent to the disk drive through the device interface controller, or data or states of the disk drive are changed from the device interface format to the host interface format and sent to the host.

### BACKGROUND OF THE INVENTION

1. Field of the Invention

The invention relates to the technical field of a bridge system and, more particularly, to a USB to a SATA bridge system.

2. Description of Related Art

Typical digital electric appliances (e.g., digital versatile disk (DVD) recorders, Karaoke, electric accompaniment machines, and the like) use hard disks to store image data. The hard disks are embedded in the digital electric appliances and cannot be expanded easily due to the fixed storage capacities at ex-factory. In addition, the embedded operating systems used by the factories are different, and thus it is required to appropriately modify an operating system and storage device for use by different factories. Moreover, a damaged storage device has to be sent back to its original manufacturer for replacement.

To overcome this, a typical technology uses a USB flash memory to store image data. However, the flash memory is expensive and requires a lot of storage capacity for the DVD format than the storage capacity for the VCD format. As cited, the USB flash memory is not suitable for storing image data. Another typical solution uses a USB to an ATA bridge to connect digital electric appliances with an ATA disk drive. However, such a way can overcome the insufficient storage capacity but needs to shut down a system in order to fit a new ATA disk drive.

Therefore, it is desirable to provide an improved system to mitigate and/or obviate the aforementioned problems.

### SUMMARY OF THE INVENTION

The object of the invention is to provide a bridge system for heter-serial interfaces, which can overcome the prior problem that the storage capacity cannot be expanded and obtain the hot-plug function to thus improve usage convenience.

In accordance with one aspect of the present invention, there is provided a bridge system for heter-serial interfaces, which is connected to a host. The system includes a host interface controller, a memory, a controller and a device interface controller. The host interface controller is electrically connected to the host for receiving commands and data sent by the host or sending the data to the host. The memory is connected to the host interface controller for temporarily storing the data. The controller is connected to the memory and the host interface controller for accessing the commands sent by the host and stored in the memory. The device interface controller has one end connected to the controller and the memory for sending the data to the memory or receiving the data from the memory, and the other end connected to a disk drive. The controller controls the host interface controller and the device interface controller such that the data or commands sent by the host are changed from a host interface format to a device interface format and sent to the disk drive through the device interface controller, or data or states of the disk drive are changed from the device interface format to the host interface format and sent to the host.

In accordance with another aspect of the present invention, there is provided a bridge system for heter-serial interfaces, which is connected to a host. The system includes a USB interface controller, a memory, a controller and a SATA interface controller. The USB interface controller is electrically connected to the host for receiving commands and data sent by the host or sending the data to the host. The memory is connected to the USB interface controller for temporarily storing the data. The controller is connected to the memory and the USB interface controller for accessing the commands sent by the host and stored in the memory. The SATA interface controller has one end connected to the memory for sending the data to the memory or receiving the data from the memory, and the one end is also connected to the controller, and the other end is connected to a disk drive. The controller controls the USB interface controller and the SATA interface controller, such that the data or commands sent by the host are changed from a USB format to a SATA format and sent to the disk drive through the SATA interface controller, or data or states of the disk drive are changed from the SATA format to the USB format and sent to the host.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a bridge system for heter-serial interfaces in accordance with the invention;

FIG. 2 is a flowchart of changing from a USB format to a SATA format by the bridge system of FIG. 1 in accordance with the invention;

FIG. 3 is a schematic diagram of an operation wherein a host sends a device descriptor request packet to a bridge system with a device ID equal to 0 in accordance with the invention;

FIG. 4 is a schematic diagram of an operation wherein a host sends a set address request packet to a bridge system with a device ID equal to 0 in accordance with the invention;

FIG. 5 is a schematic diagram of an operation that a host uses an output pipeline to send an SCSI-2/UFI command to a bridge system in accordance with the invention;

FIG. 6 is a data format of a CBW packet in accordance with the invention;

FIG. 7 is a schematic diagram of a list in which SCSI commands are grouped into three types of direct conversion, partial conversion/emulation, and emulation in accordance with the invention;

FIG. 8 is a schematic diagram of converting command ‘SCSI READ 10’ into command ‘ATA READ DMA’ in accordance with the invention;

FIG. 9 is a schematic diagram of converting command ‘SCSI READ 6’ into command ‘SCSI READ 10’ in accordance with the invention;

FIG. 10 is a schematic diagram of converting command ‘SCSI WRITE 6’ into command ‘SCSI WRITE 10’ in accordance with the invention;

FIG. 11 is a schematic diagram of converting command ‘SCSI MODE SENSE 6’ into command ‘SCSI MODE SENSE 10’ in accordance with the invention;

FIG. 12 is a schematic diagram of converting command ‘SCSI MODE SELECT 6’ into command ‘SCSI MODE SELECT 10’ in accordance with the invention; and

FIG. 13 is a flowchart of an emulation of pulling a disk drive out of a SATA port in accordance with the invention.

### DETAILED DESCRIPTION OF THE PREFERRED EMBODIMENT

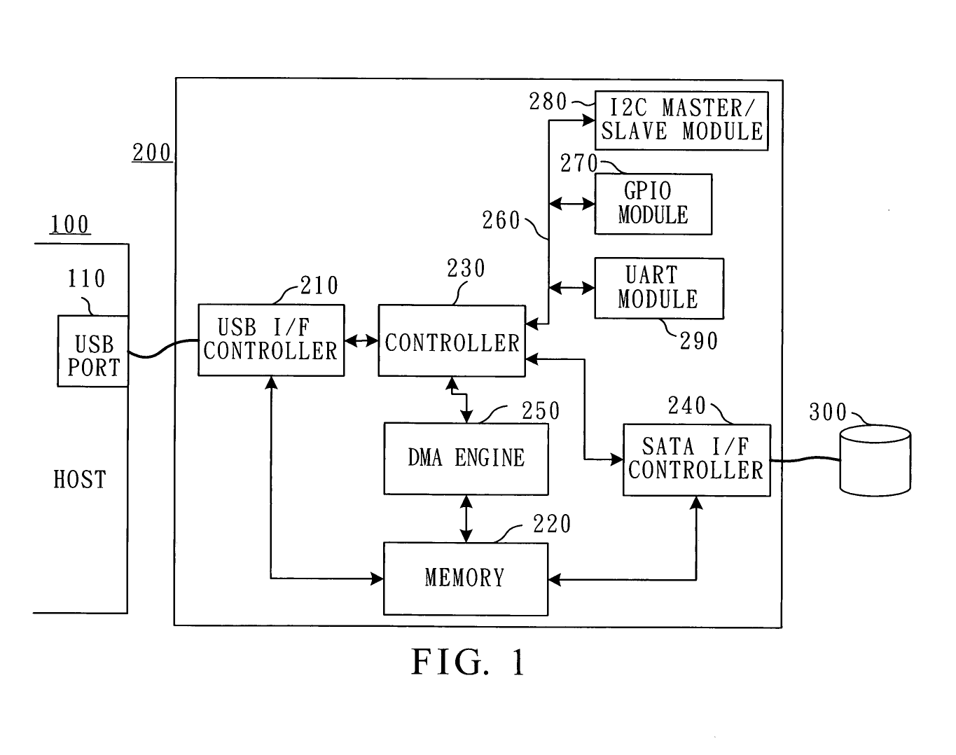

FIG. 1 is a block diagram of a bridge system 200 for heter-serial interfaces in accordance with the invention. The bridge system 200 is connected to a host 100 to overcome the prior problem of inexpansible storage capacity and to obtain the hot-plug function for improving the usage convenience. The bridge system 200 includes a host interface controller 210, a memory 220, a controller 230, a device interface controller 240, a direct memory access (DMA) engine 250, a first bus 260, a general-purpose input/output (GPIO) module 270, an inter-IC (I2C) master/slave module 280 and a universal asynchronous receiver/transmitter (UART) module 290.

The host interface controller 210 is a universal serial bus (USB) interface controller, which is electrically connected to a USB port 110 of the host 100 to receive commands and data sent by the host 100 or send the data to the host 100. The memory 220 is connected to the host interface controller 210 to temporarily store data. The controller 230 is connected to the memory 220 and the host interface controller 210 to access the commands sent by the host 100 and stored in the memory 220.

The DMA engine 250 is connected to the memory 220 to control an access of the memory 220. The DMA engine 250 is connected to and controlled by the controller 230. The device interface controller 240 is a serial advanced technology attachment (SATA) interface controller having one end connected to the memory 220 to send or receive the data to or from the memory 220 and having the other end connected to a disk drive 300.

The controller 230 controls the host interface controller 210 and the device interface controller 240 such that the data or commands sent by the host 100 are changed from a USB format to a SATA format and sent to the disk drive 300 through the device interface controller 240, or data or states of the disk drive 300 are changed from the SATA format to the USB format and sent to the host 100.

The first bus 260 receives or transmits the data. The GPIO module 270 is connected to the first bus 260 such that the controller 230 can access a peripheral device through the GPIO module 270 and the first bus 260. The I2C master/slave module 280 is connected to the first bus 260 such that the controller 230 can access an I2C bus through the I2C module 280 and the first bus 260. The UART module 290 is connected to the first bus 260 such that the controller 230 can access a UART bus through the UART module 290 and the first bus 260.

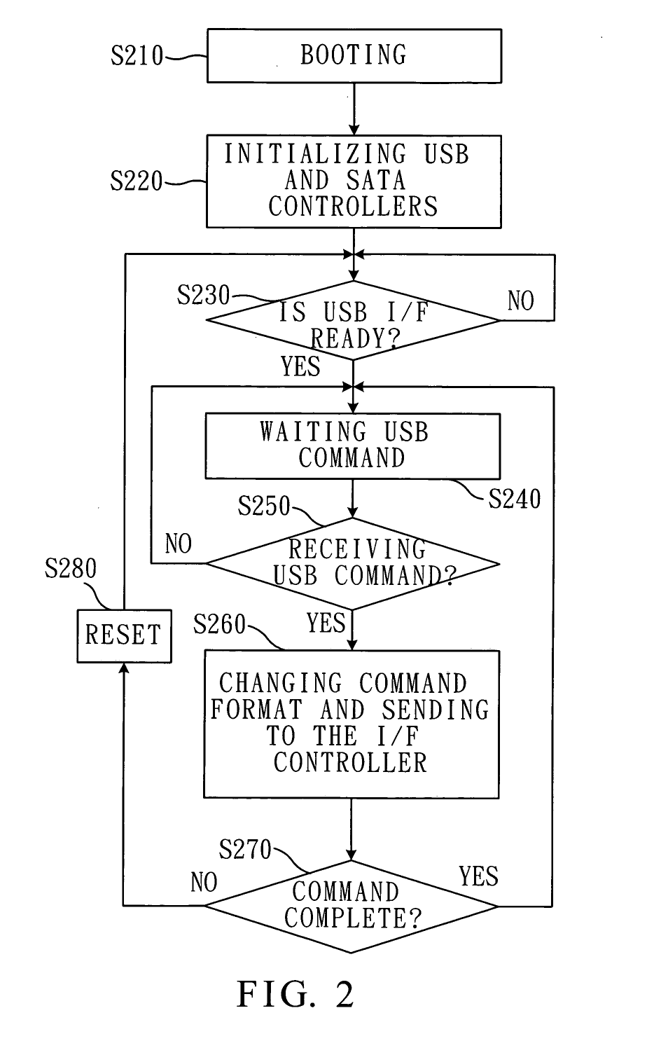

FIG. 2 is a flowchart of changing from the USB format to the SATA format by the bridge system of FIG. 1 in accordance with the invention. As shown, step S210 executes a boot routine. Step S220 initializes the USB interface controller 210 and the SATA interface controller 240. Step S230 determines if the USB interface is ready; if yes, step S240 is executed; and if not, the procedure returns to step S230.

Because the USB bus provides the hot-plug function, the host 100 is known that a low-, full- or high-speed USB device is connected to the USB bus when the host 100 detects that the signal line USBD− or USBD+ of the USB bus has a pull-up resistor. Thus, when the bridge system 200 is plugged into the USB port 110 through a USB cable, the host 100 can detect that the bridge system 200 is connected to the USB bus.

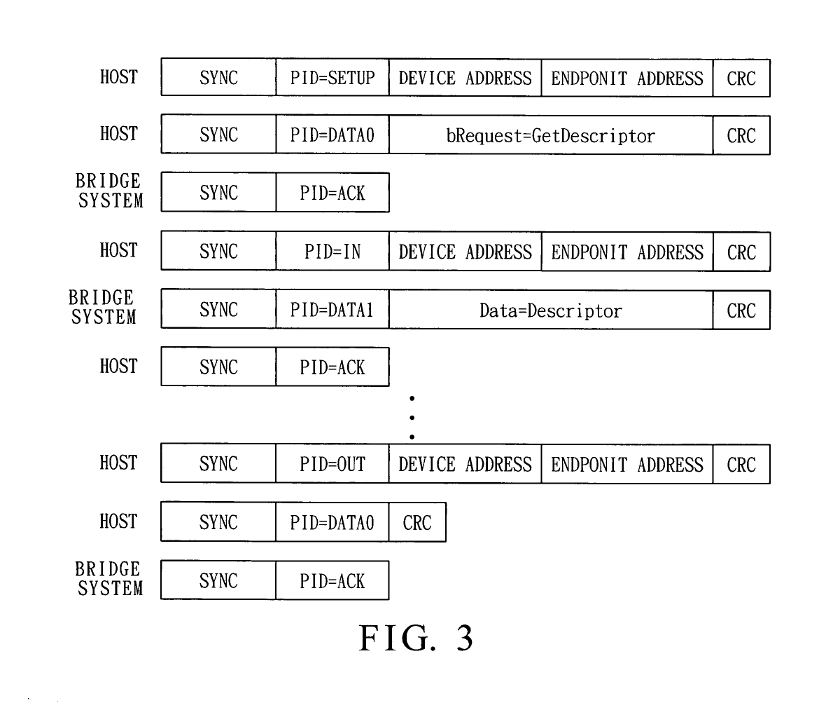

Accordingly, the host 100 sends a bus reset signal to reset the bridge system 200. In this case, the bus reset signal makes the signals USBD− and USBD+stay at a low potential state for at least 10 ms or more. Also, the bus reset signal forces the bridge system 200 to stay at a predetermined device address (address 0). As shown in FIG. 3, the host 100 uses a predetermined endpoint 0 for the control pipe to send a device descriptor request packet to the bridge system 200 at the predetermined address 0, wherein the field bRequest in this packet is set as ‘GetDescriptor’. The bridge system 200 sends the previous eight bytes of the device descriptor back to the host 100.

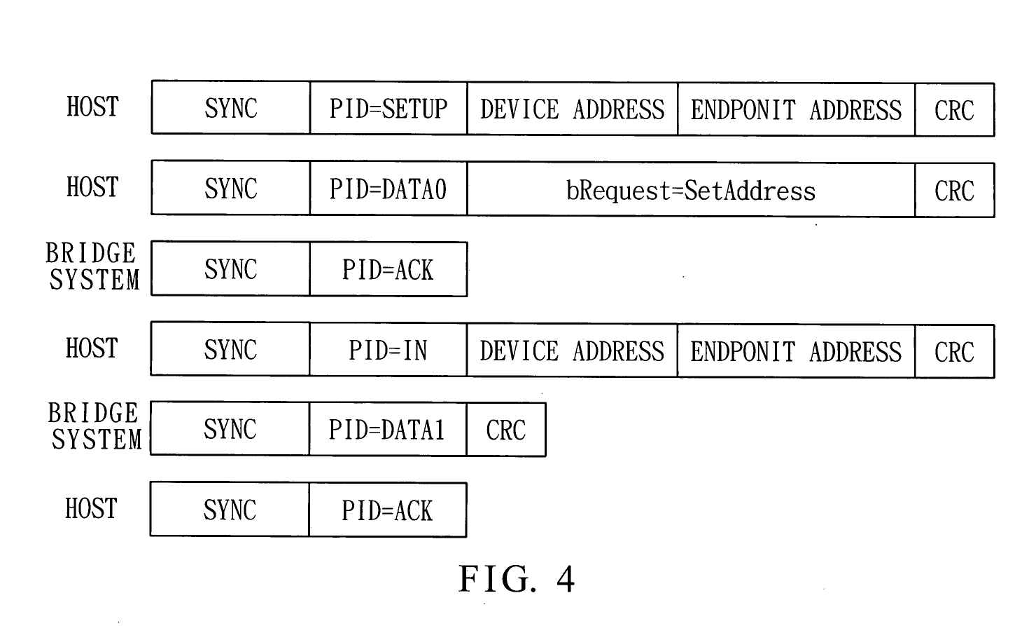

The host 100 assigns a unique address (such as 0000001_{b}=01ₕ) to the bridge system 200 by sending a set address request packet, wherein the field bRequest in this packet is set as ‘SetAddress’. Thus, the address of the bridge system 200 is set to 01ₕ. FIG. 4 shows the packet transfer between the host 100 and the bridge system 200.

Next, the host 100 uses the address 01ₕ to send a device descriptor request packet to the bridge system 200, wherein the field bRequest is set as ‘GetDescriptor’. After the device descriptor request packet is received, the bridge system 200 at the address 01ₕ uses data packets DATA0, DATA1 to send a corresponding device descriptor back to the host 100. Similarly, the packet transfer between the host 100 and the bridge system 200 is shown as the same as that of FIG. 3, wherein the Device Address field is 01ₕ.

The host 100 uses the address 01ₕ to send a configuration description request packet to the bridge system 200, wherein the field bRequest is set as ‘GetConfiguration’. After the configuration descriptor request packet is received, the bridge system 200 uses data packets DATA0, DATA1 to send a corresponding configuration descriptor back to the host 100. Similarly, the packet transfer between the host 100 and the bridge system 200 is shown as the same as that of FIG. 3, wherein the field bRequest is ‘GetConfiguration’. In this embodiment, the bridge system 200 is a storage device such that the DeviceClass and DeviceSubClass fields of the configuration descriptor sent to the host 100 is a serial number of the storage device.

The host 100 selects a bulk storage device interface in accordance with the received configuration descriptor, thereby calling a device driver to access the bridge system 200. The host 100 also selects a Bulk-only protocol in accordance with an InterfaceProtocol field of a received interface descriptor, thereby communicating with the bridge system 200.

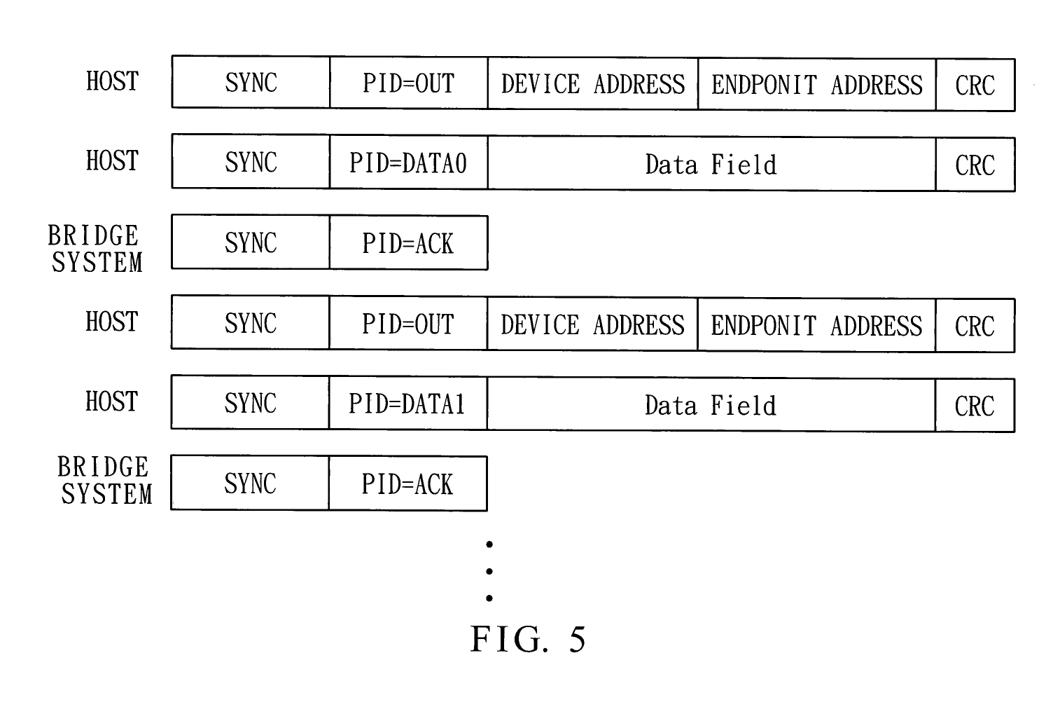

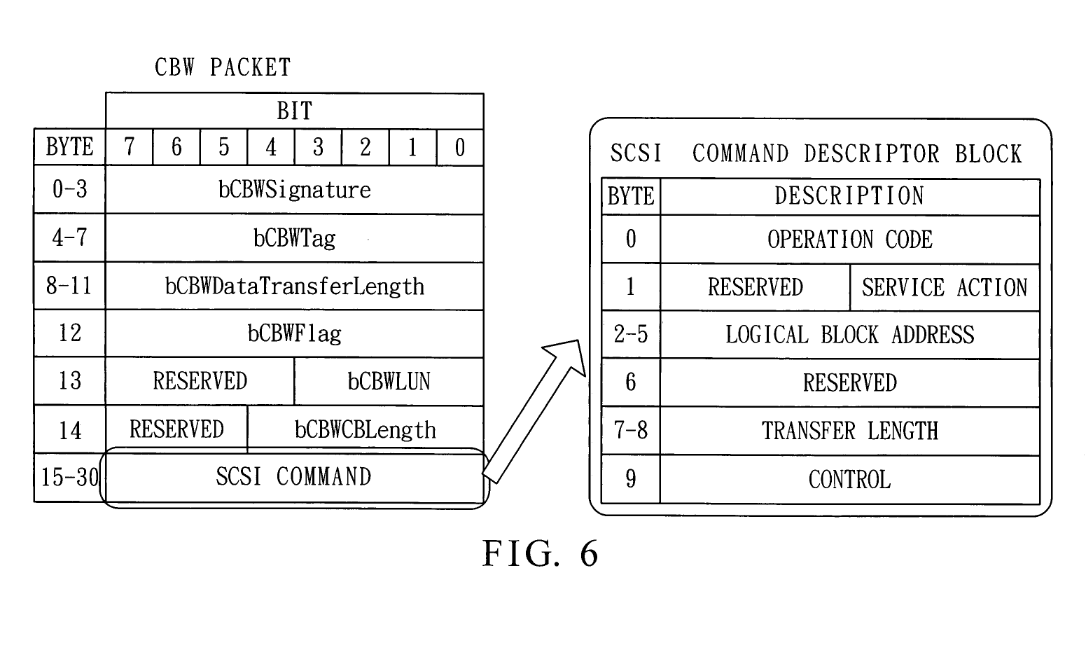

For accessing a typical file, the host 100 uses the first output pipeline (Out-Pipe) to send a SCSI-2/UFI standard command. At this point, data transfer between the host 100 and the bridge system 200 is shown in FIG. 5, wherein the data field contains a Command Block Wrapper (CBW) packet. The format of the CBW packet is shown in FIG. 6, wherein the SCSI command field contains the UFI/SCSI-2 standard command, and other fields contain the parts of Bulk-only protocol and associated description.

Step S240 waits for a USB command sent by the host 100. In step S250, it determines whether the USB command is received; if yes, step S260 is executed; and if not, the procedure returns to step S240. Step S260 changes the command from the USB format to the SATA format and sends the SATA format command to the SATA interface controller 240.

In step S260, as shown in FIG. 6, the controller 230 extracts the SCSI command field from a CBW packet and accordingly forms an SCSI command descriptor block. Next, the controller 230 converts the SCSI command descriptor block into an ATA or ATAPI command descriptor block.

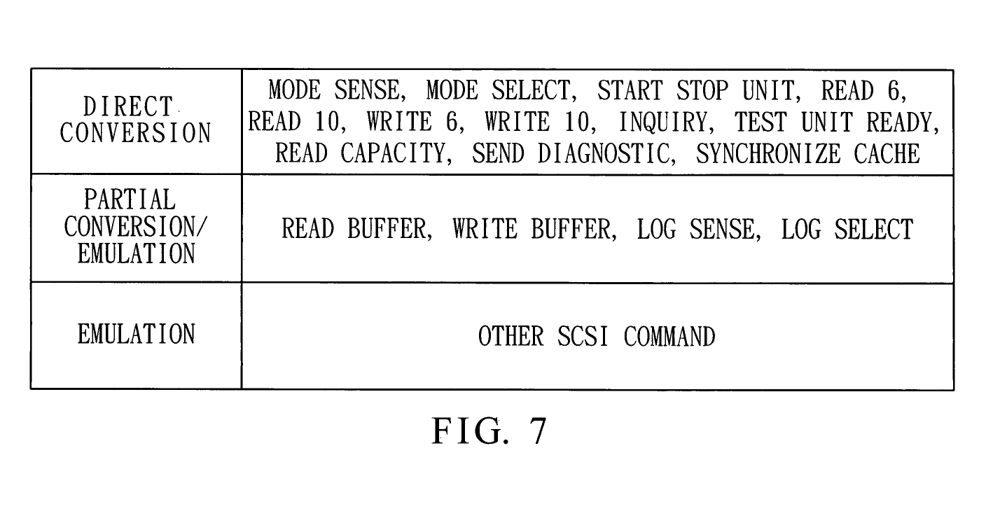

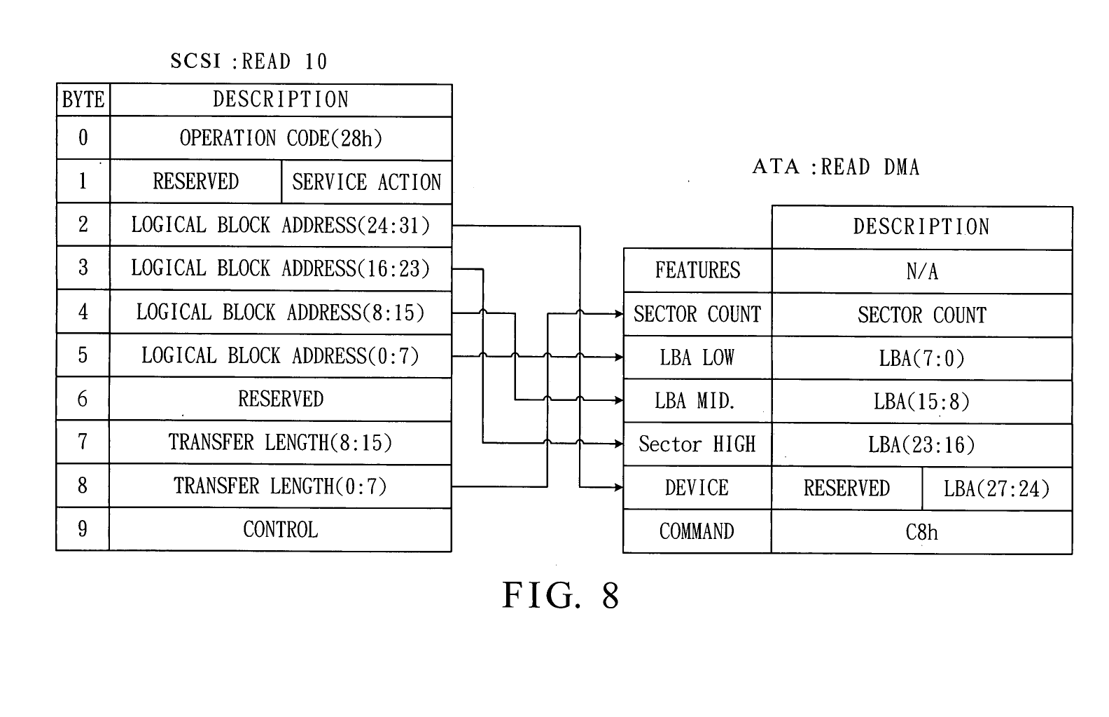

As shown in FIG. 7, while the SCSI command descriptor block is converted into the ATA or ATAPI command descriptor block, the SCSI commands can be grouped into three types of direct conversion, partial conversion/emulation and emulation, wherein the direct conversion SCSI commands have corresponding ATA commands. FIG. 8 is a schematic diagram of directly converting command ‘SCSI READ 10’ into command ‘ATA READ DMA’. The controller 230 converts command ‘SCSI READ 10’ sent by the host 100 into command ‘ATA READ DMA’ and sends the command ‘ATA READ DMA’ to the SATA interface controller 240.

The partial conversion/emulation SCSI commands have corresponding ATA commands, but the ATA commands provide functions fewer than the SCSI commands. Thus, some functions are achieved by emulation. For example, command ‘SCSI READ BUFFER’ can read the length of a buffer in a disk drive, the identifier of a disk drive and a special location data of a disk drive, but command ‘ATA READ_BUFFER’ can read only 512 bytes from a buffer. Accordingly, the controller 230 converts command ‘SCSI READ BUFFER’ sent by the host 100 into command ‘ATA READ_BUFFER’, and filters data in the buffer to obtain the special location data and to send the special location data to the host 100.

The emulation SCSI commands have no corresponding ATA commands and the functions thereof are achieved by emulation. For example, command ‘SCSI FORMAT UNIT’ can set sectors on a disk drive to ‘0’, without any corresponding ATA command. Accordingly, the controller 230 converts command ‘SCSI FORMAT UNIT’ sent by the host 100 into command ‘ATA WRITE DMA’ and sets the write data to ‘0’ to thus format a disk drive.

While the SCSI command descriptor block is converted into the ATAPI, the controller 230 does not require converting commands supported by an ATAPI device, except for commands ‘SCSI READ 6’, ‘WRITE 6’, ‘MODE SENSE 6’ and ‘MODE SELECT 6’.

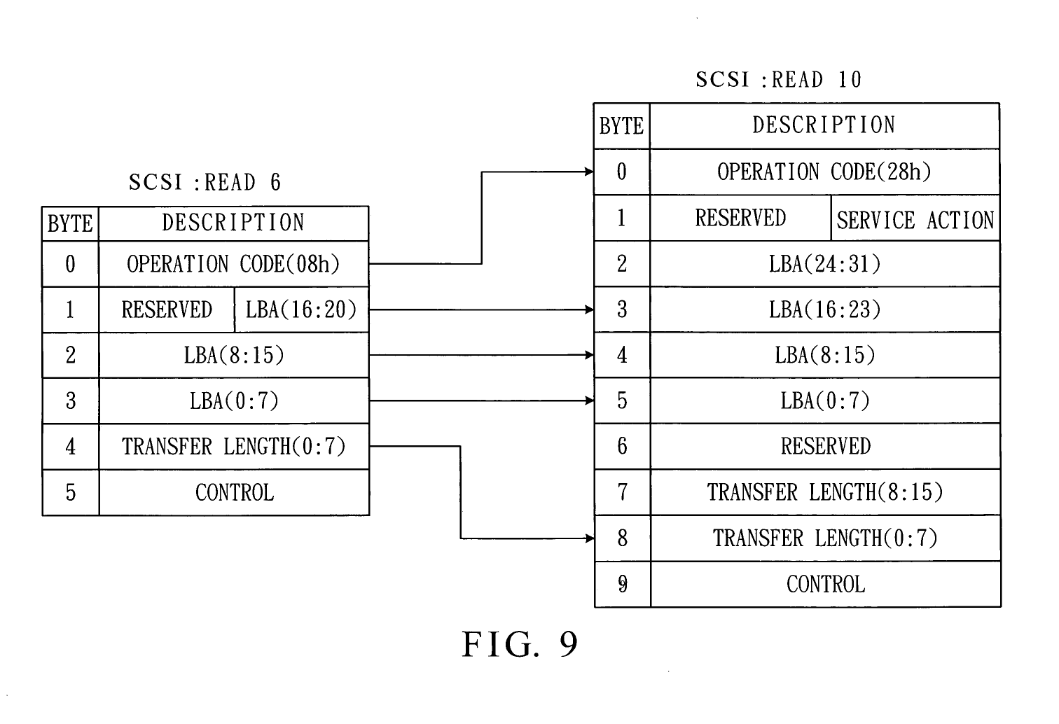

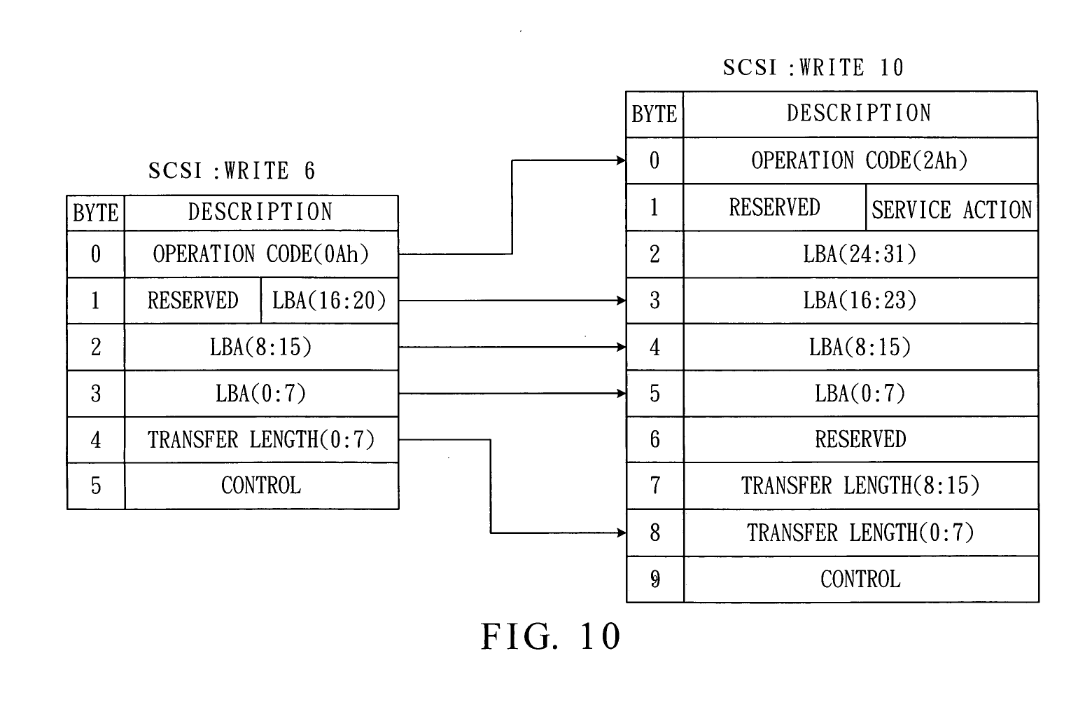

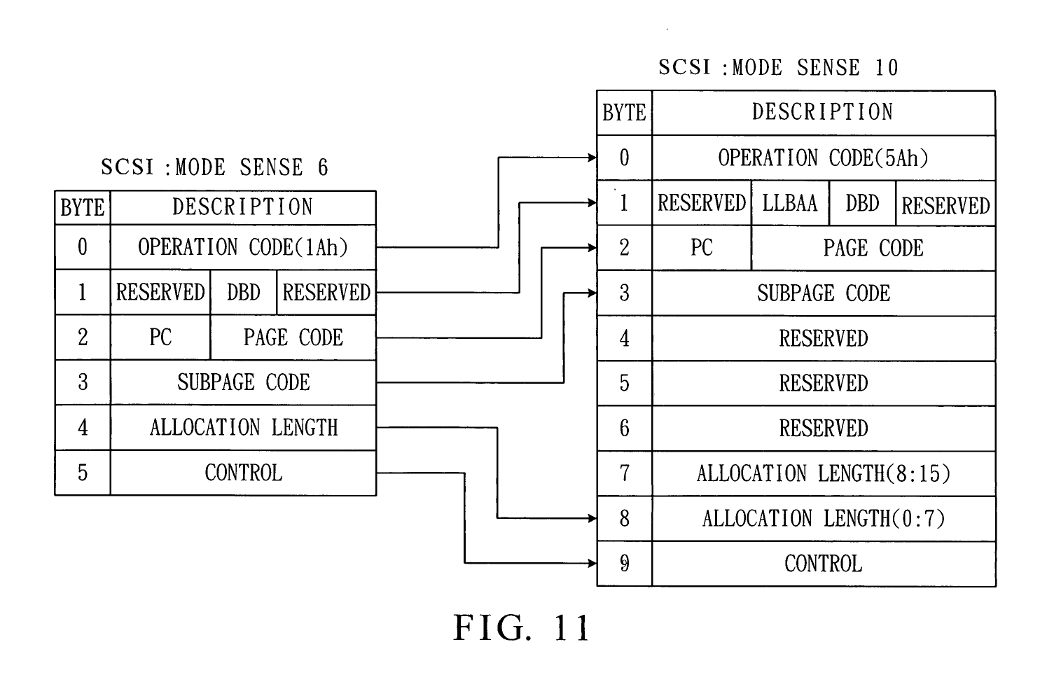

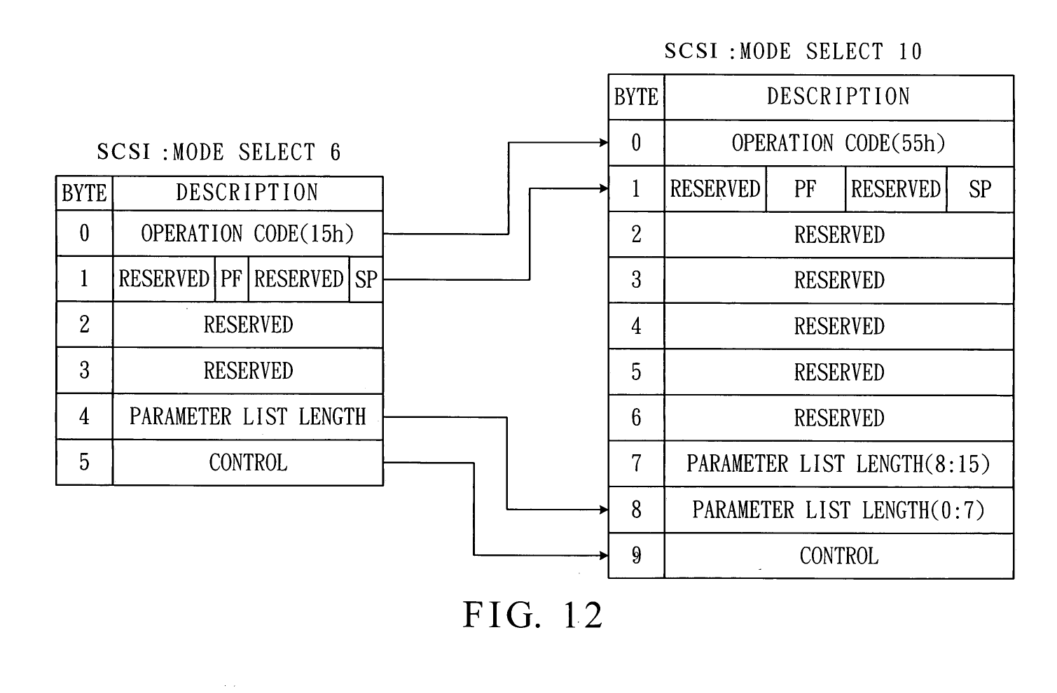

FIG. 9 is a schematic diagram of converting command ‘SCSI READ 6’ into command ‘SCSI READ 10’, which is supported by the ATAPI device and thus can be sent to the SATA interface controller 240 directly. Accordingly, FIG. 10 is a schematic diagram of converting command ‘SCSI WRITE 6’ into command ‘SCSI WRITE 10’. FIG. 11 is a schematic diagram of converting command ‘SCSI MODE SENSE 6’ into command ‘SCSI MODE SENSE 10’ in accordance with the invention. FIG. 12 is a schematic diagram of converting command ‘SCSI MODE SELECT 6’ into command ‘SCSI MODE SELECT 10’.

Step S270 determines if the command is complete; if yes the procedure returns to step S240 to wait for a next USB command; if not, step S280 is executed to reset the bridge system 200, and the procedure returns to step S230.

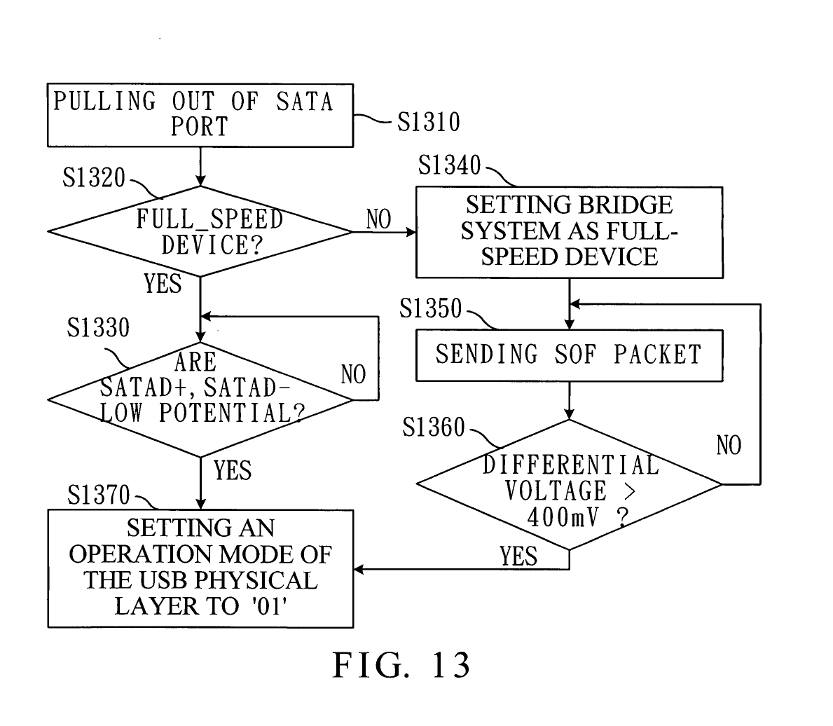

Because both the USB interface and the SATA interface support the hot-plug, a flowchart of an emulation of pulling a disk drive 300 out of a SATA port in accordance with the invention is shown in FIG. 13. In step S1310, the disk drive 300 is pulled out of the SATAport. In step S1320, the controller 230 determines if the bridge system 200 is a full-speed USB device; if yes, step S1330 is executed; and if not, step S1340 is executed.

In step S1330, the controller 230 determines if the signal lines SATAD+ and SATAD− on the SATA bus are in low potential for ensuring the disk drive 300 is pulled out of the SATA port. If the signal lines SATAD+ and SATAD− on the SATA bus are in low potential, it indicates that the disk drive 300 is out of the SATA port and step S1370 is executed, and conversely, the procedure returns to step S1330.

In step S1340, the controller 230 sets the bridge system 200 as the full-speed USB device. In step S1350, the controller 230 sends a start of frame (SOF) packet through the signal lines SATAD+ and SATAD− on the SATA bus. Step S1360 determines if a differential voltage of the signal lines SATAD+ and SATAD− on the SATA bus is greater than a threshold; if yes, it indicates that the disk drive 300 is pulled out of the SATA port and step S1370 is executed; and if not, the procedure returns to step S1350.

When the disk drive 300 is plugged into the SATA port, the differential voltage of the signal lines SATAD+ and SATAD− is about 400 mV because of terminal resistance of the disk drive 300. Conversely, when the disk drive 300 is pulled out, the differential voltage is about 800 mV because the terminal resistance is removed. Accordingly, when the differential voltage is greater than 400 mV, it is ensured that the disk drive 300 is pulled out.

Step S1370 sets an operation mode of the USB physical layer to ‘01’. An operating system of the host 100 typically polls a USB device on the USB port every fixed interval in order to check whether the USB device is out or not. When the disk drive 300 is pulled out but the bridge system 200 remains on the USB port 110, the operation mode of the USB physical layer is set to ‘01’ in order to cause the operating system to misjudge that the bridge system 200 is removed.

In view of the foregoing, it is known that the bridge system 200 can avoid applying expensive flash memory and the problem that a USB to ATA bridge cannot support the hot-plug function. Thus, when an ATA disk drive has insufficient capacity, a new ATA can be changed without the system shutdown so as to improve usage convenience.

Although the present invention has been explained in relation to its preferred embodiment, it is to be understood that many other possible modifications and variations can be made without departing from the spirit and scope of the invention as hereinafter claimed.

What is claimed is:

1. A bridge system for heter-serial interfaces, connected to a host, the bridge system comprising:
a host interface controller, which is connected to the host for receiving commands and data sent by the host or sending the data to the host;
a memory, which is connected to the host interface controller for storing the data;
a controller, which is connected to the memory and the host interface controller for accessing the commands sent by the host and stored in the memory; and
a device interface controller, which has one end connected to the controller and the memory for sending the data to the memory or receiving the data from the memory, and another end connected to a disk drive;
wherein the controller controls the host interface controller and the device interface controller such that the data or commands sent by the host are changed from a host interface format to a device interface format and sent to the disk drive through the device interface controller, or data or states of the disk drive are changed from the device interface format to the host interface format and sent to the host.

2. The system as claimed in claim 1, further comprising a direct memory access (DMA) engine connected to the memory for controlling an access of the memory.

3. The system as claimed in claim 2, wherein the DMA engine is connected to and controlled by the controller.

4. The system as claimed in claim 1, wherein the host interface controller is a universal serial bus (USB) interface controller for connecting to a USB port of the host.

5. The system as claimed in claim 1, wherein the device interface controller is a serial advanced technology attachment (SATA) interface controller for connecting to a SATA disk drive.

6. The system as claimed in claim 1, further comprising:
a first bus, which is connected to the controller for receiving and transmitting the data; and
a general-purpose input and output (GPIO) module, which is connected to the first bus such that the controller is able to access a peripheral device through the GPIO module.

7. The system as claimed in claim 6, further comprising an inter-IC (I2C) master/slave module, which is connected to the first bus such that the controller is able to access an I2C bus through the I2C module.

8. The system as claimed in claim 6, further comprising a universal asynchronous receiver and transmitter (UART) module, which is connected to the first bus such that the controller is able to access a UART bus through the UART module.

9. A USB to a SATA bridge system, connected to a host, the bridge system comprising:
a USB interface controller, which is connected to the host for receiving commands and data sent by the host or sending the data to the host;
a memory, which is connected to the USB interface controller for storing the data;
a controller, which is connected to the memory and the USB interface controller for accessing the commands sent by the host and stored in the memory; and
a SATA interface controller, which has one end connected to the controller and the memory for sending the data to the memory or receiving the data from the memory, and the other end connected to a disk drive;
wherein the controller controls the USB interface controller and the SATA interface controller, such that the data or commands sent by the host are changed from a USB format to a SATA format and sent to the disk drive through the SATA interface controller, or data or states of the disk drive are changed from the SATA format to the USB format and sent to the host.

10. The system as claimed in claim 9, further comprising a direct memory access (DMA) engine connected to the memory for controlling an access of the memory.

11. The system as claimed in claim 10, wherein the DMA engine is connected to and controlled by the controller.

12. The system as claimed in claim 9, further comprising:
a first bus, which is connected to the controller for receiving and transmitting the data; and
a general-purpose input and output (GPIO) module, which is connected to the first bus such that the controller is able to access a peripheral device through the GPIO module.

13. The system as claimed in claim 12, further comprising an inter-IC (I2C) master/slave module, which is connected to the first bus such that the controller is able to access an I2C bus through the I2C module.

14. The system as claimed in claim 12, further comprising a universal asynchronous receiver and transmitter (UART) module, which is connected to the first bus such that the controller is able to access a UART bus through the UART module.
